(19) United States
(12) Patent Application Publication
(10) Pub. No.: US 2025/0236551 A1
(43) Pub. Date: Jul. 24, 2025

(54) METHOD FOR MANUFACTURING OPTICAL FIBER

(71) Applicant: SUMITOMO ELECTRIC INDUSTRIES, LTD., Osaka (JP)

(72) Inventors: Takahiro NOMURA, Osaka (JP); Iwao OKAZAKI, Osaka (JP)

(21) Appl. No.: 19/033,989

(22) Filed: Jan. 22, 2025

(30) Foreign Application Priority Data
Jan. 22, 2024 (JP) 2024-007314

(51) Int. Cl. C03B 37/012

(52) U.S. Cl. CPC C03B 37/01245; C03B 37/0126; C03B 2205/08

(57) ABSTRACT

A method for manufacturing an optical fiber. The method includes a drawing step of drawing a glass base material while feeding the glass base material to a heating furnace, to manufacture an optical fiber. The glass base material includes a core rod and a cladding tube into which the core rod is inserted. A support tube is bonded to an upper end of the cladding tube, to communicate with a gap between the core rod and the cladding tube. The drawing step includes bringing the gap and an internal space of the support tube into a state of being lower in pressure than atmospheric pressure.

### CROSS-REFERENCE TO RELATED APPLICATIONS

This application is based on and claims priority under 35 USC 119 from Japanese Patent Application No. 2024-007314 filed on Jan. 22, 2024, the entire content of which is incorporated herein by reference.

### TECHNICAL FIELD

The present disclosure relates to a method for manufacturing an optical fiber.

### BACKGROUND ART

JP2010-173895A discloses a method for manufacturing an optical fiber in a state in which a support tube is bonded to a glass base material. The glass base material is fused in a heating furnace and thinned to manufacture an optical fiber.

The method for manufacturing an optical fiber disclosed in JP2010-173895A is a method called a Rod-In-Tube (RIT).

However, in RIT drawing, preventing occurrence of a spike is an object. One of the causes of occurrence of a spike is considered to be the intrusion of foreign matter into the glass base material before and during drawing.

### SUMMARY OF INVENTION

Aspect of non-limiting embodiments of the present disclosure relates to provide a method for manufacturing an optical fiber in which occurrence of a spike is prevented.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a method for manufacturing an optical fiber, the method includes:
a drawing step of drawing a glass base material while feeding the glass base material to a heating furnace, to manufacture an optical fiber,
in which the glass base material includes a core rod and a cladding tube into which the core rod is inserted,
in which a support tube is bonded to an upper end of the cladding tube, to communicate with a gap between the core rod and the cladding tube,
in which the drawing step includes bringing the gap and an internal space of the support tube into a state of being lower in pressure than atmospheric pressure, and
in which an atmosphere within 1 m around the glass base material is made into a clean environment in which the number of particles having a size of 0.3 μm or more and less than 0.5 μm is 15,000 particles/CF or less and in which the number of particles having a size of 0.5 μm or more and less than 1.0 μm is 3,500 particles/CF or less.

### BRIEF DESCRIPTION OF DRAWINGS

Exemplary embodiment(s) of the present invention will be described in detail based on the following figures, wherein:

FIG. 1 is a schematic view of a manufacturing apparatus for an optical fiber according to an embodiment; and

FIG. 2 is a cross-sectional view of an enclosure and a glass base material.

### DESCRIPTION OF EMBODIMENTS

### Description of Embodiments of Present Disclosure

First, aspects of the present disclosure will be listed and described.

(1) A method for manufacturing an optical fiber according to an aspect of the present disclosure includes:
a drawing step of drawing a glass base material while feeding the glass base material to a heating furnace to manufacture an optical fiber,
in which the glass base material includes a core rod and a cladding tube into which the core rod is inserted,
in which a support tube is bonded to an upper end of the cladding tube to communicate with a gap between the core rod and the cladding tube,
in which the drawing step includes bringing the gap and an internal space of the support tube into a state of being lower in pressure than atmospheric pressure, and
in which an atmosphere within 1 m around the glass base material is made into a clean environment in which the number of particles having a size of 0.3 μm or more and less than 0.5 μm is 15,000 particles/CF or less and the number of particles having a size of 0.5 μm or more and less than 1.0 μm is 3,500 particles/CF or less.

According to the method for manufacturing an optical fiber described above, since the atmosphere within 1 m around the glass base material is the clean environment described above, the foreign matter is less likely to enter the periphery of the glass base material. Accordingly, since foreign matter is less likely to adhere to the glass base material, the occurrence of spikes in the manufacture of an optical fiber is prevented.

(2) In the method for manufacturing an optical fiber according to (1) described above,
the drawing step may include blowing clean air such that the clean air hits the glass base material.

In the method for manufacturing an optical fiber described above, by blowing clean air such that the clean air hits the glass base material, the clean environment around the glass base material is maintained. Accordingly, adhesion of foreign matter to the glass base material in the drawing step is prevented.

(3) In the method for manufacturing an optical fiber according to (2) described above,
the drawing step may include blowing the clean air such that the clean air hits the glass base material from at least two different directions.

In the method for manufacturing an optical fiber described above, by blowing the clean air such that the clean air hits the glass base material from the two different directions, the clean environment around the glass base material is more easily maintained. Accordingly, adhesion of foreign matter to the glass base material in the drawing step is prevented.

(4) In the method for manufacturing an optical fiber according to any one of (1) to (3) described above,
in the drawing step, positive pressure within 1 m around the glass base material may be 5 Pa or more higher than atmospheric pressure.

According to the method for manufacturing an optical fiber described above, by providing the positive pressure within 1 m around the glass base material relative to the space outside 1 m around the glass base material, it is particularly possible to prevent foreign matter from being mixed into the periphery of the glass base material from the space outside 1 m around the glass base material. Accordingly, adhesion of foreign matter to the glass base material in the drawing step is prevented.

(5) In the drawing step in the method for manufacturing an optical fiber according to any one of (1) to (4) described above,
a periphery of the glass base material may be covered with an enclosure that is provided above the heating furnace, and clean air may be blown from the enclosure.

According to the method for manufacturing an optical fiber described above, the periphery of the glass base material is covered with the enclosure, and thus adhesion of foreign matter to the glass base material is prevented. Further, clean air is blown from the surfaces of the enclosure, and thus adhesion of foreign matter to the glass base material in the drawing step is prevented.

### Details of Embodiments of Present Disclosure

A specific example of a method for manufacturing an optical fiber according to an embodiment of the present disclosure will be described below with reference to the drawings.

The present disclosure is not limited to these exemplifications, but is indicated by the scope of claims, and is intended to include all changes within a scope and meaning equivalent to the scope of claims.

In the description of the present embodiment, a reference sign U shown in the drawings indicates the upward direction. A reference sign D indicates the downward direction.

A reference sign L indicates a leftward direction. A reference sign R indicates a rightward direction.

### <Manufacturing Apparatus>

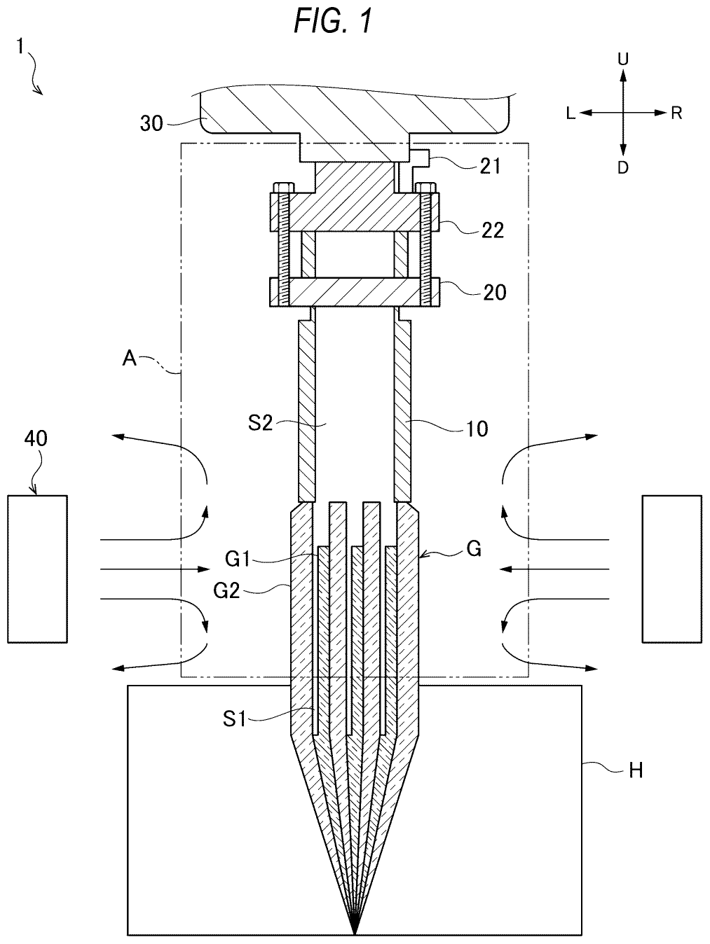

FIG. 1 is a schematic view of a manufacturing apparatus 1 for an optical fiber according to the present embodiment. The manufacturing apparatus 1 illustrated in FIG. 1 manufactures an optical fiber by a drawing step in which a glass base material G is drawn while being fed to a heating furnace H. The heating furnace H is configured to fuse the glass base material G by a heater or the like.

The glass base material G includes a core rod G1. The core rod G1 is made of quartz glass. The core rod G1 forms the core portion in the optical fiber.

The glass base material G includes a cladding tube G2. The cladding tube G2 is made of quartz glass. The core rod G1 is inserted into the cladding tube G2. A gap S1 is formed between the cladding tube G2 and the core rod G1. The cladding tube G2 forms a cladding portion that is provided around the core portion in the optical fiber. A refractive index adjusting agent is added to at least one of the core rod G1 and the cladding tube G2, and the core rod G1 has a higher optical refractive index than the cladding tube G2.

A support tube 10 is bonded to an upper end of the cladding tube G2. An internal space S2 of the support tube 10 communicates with the gap S1 between the cladding tube G2 and the core rod G1. The support tube 10 is made of, for example, quartz glass. The length of the support tube 10 may be, for example, 250 mm or more and 1250 mm or less.

The manufacturing apparatus 1 for an optical fiber includes a gripping portion 20, a feeder including a movable portion 30, and an enclosure 40.

The gripping portion 20 is configured to grip the upper portion of the support tube 10. The gripping portion 20 is made of metal. The gripping portion 20 is formed with an exhaust port 21 and a lid portion 22.

A recess is formed on the side surface of the support tube 10, and the glass base material G and the support tube 10 are suspended by hanging the gripping portion 20 in the recess. Together with the lid portion 22, the gripping portion 20 grips the upper portion of the support tube 10 by clamping the upper portion with a fastening component such as a bolt. The lid portion 22 is fixed to the feeder.

The exhaust port 21 communicates with the gap S1 between the core rod G1 and the cladding tube G2 and the support tube 10. The gas in the gap S1 and the internal space S2 is exhausted from the support tube through the exhaust port, and the gap S1 and the internal space S2 become negative pressure.

The glass base material G, the support tube 10, and the gripping portion 20 are displaced by the feeder. As the manufacture of the optical fiber progresses, the feeder gradually lowers the glass base material G, the support tube 10, and the gripping portion 20, thereby gradually feeding the glass base material G, the support tube 10, and the gripping portion 20 into the heating furnace. The feeder includes the movable portion 30 that is displaced together with the glass base material G.

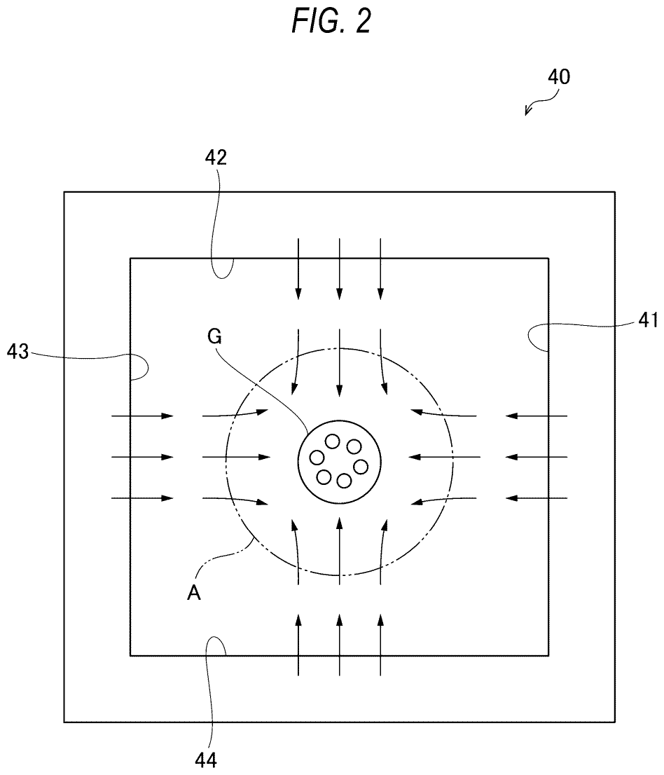

As illustrated in FIG. 1, the enclosure 40 is provided above the heating furnace H. FIG. 2 is a cross-sectional view of the enclosure 40 and the glass base material G. FIG. 2 illustrates four surfaces of the enclosure 40 that face the surface of the glass base material G. The enclosure 40 includes a first surface 41, a second surface 42, a third surface 43, and a fourth surface 44. The periphery of the glass base material G is covered with the enclosure 40 having at least four surfaces that face the glass base material G in the horizontal direction.

The enclosure 40 is configured to blow, in a direction toward the glass base material G, clean air from the first surface 41, the second surface 42, the third surface 43, and the fourth surface 44, which are the surfaces of the enclosure 40. The enclosure 40 is configured to take in air from the surface opposite to the glass base material G, and configured to remove dust by an internal filter. The clean degree of the clean air is, for example, such that the number of particles having a size of 0.3 μm or more and less than 0.5 μm is 15,000 particles/CF or less, and the number of particles having a size of 0.5 μm or more and less than 1.0 μm is 3,500 particles/CF or less.

Next, a method for manufacturing an optical fiber using the manufacturing apparatus 1 will be described. The method for manufacturing an optical fiber includes a drawing step of drawing the glass base material G while feeding the glass base material G to the heating furnace H, to manufacture an optical fiber.

In the drawing step, the glass base material G is sent to the heating furnace H by the feeder, in a state where the support tube 10 is attached to the glass base material G and the gripping portion 20 is attached to the upper portion of the support tube 10. Therefore, the glass base material G, the support tube 10, and the gripping portion 20 are displaced toward the heating furnace H at the same speed.

The method for manufacturing an optical fiber according to the present embodiment includes, in the drawing step, bringing the gap S1 and the internal space of the support tube 10 into a vacuum state. The vacuum state is a state where a specific section is filled with gas at a pressure lower than the atmospheric pressure. A hose (not shown) is attached to the exhaust port 21, and air in the gap S1 and the internal space of the support tube 10 is suctioned, such that the gap S1 and the internal space of the support tube 10 are brought into the vacuum state. Accordingly, void is prevented from being mixed into the drawn optical fiber.

Here, the two-dot chain line in FIG. 2 indicates the boundary of a region A that is located within 1 m from the surface of the glass base material G and above the heating furnace H. The method for manufacturing an optical fiber includes bringing the atmosphere in the region A into a clean environment in which the number of particles having a size of 0.3 μm or more and less than 0.5 μm is 15,000 particles/CF or less and in which the number of particles having a size of 0.5 μm or more and less than 1.0 μm is 3,500 particles/CF or less.

By providing the clean environment described above, foreign matter is less likely to be present around the glass base material G. The foreign matter may include, for example, metallic foreign matter such as brass, iron, stainless steel, and cemented carbide, alumina, Ca compounds, Na compounds, and glass powder.

The drawing step includes blowing clean air such that the clean air hits the glass base material G. In the drawing step, clean air may be blown so as to hit the glass base material G from at least two different directions. In the present embodiment, as illustrated in FIG. 2, clean air is blown from the first surface 41, the second surface 42, the third surface 43, and the fourth surface 44, which are the surfaces of the enclosure 40. Therefore, the enclosure 40 is configured to blow the clean air such that the clean air hits the glass base material G from four different directions.

In the drawing step, clean air is continuously blown. Accordingly, since the air around the glass base material G flows out above or below the enclosure 40, the clean environment of the region A is maintained. Since the clean air is blown from at least two different directions, the distance the clean air travels around the glass base material G is shorter than when the clean air is blown from one direction, and the clean air is less likely to stagnate around the glass base material G.

By blowing clean air from the enclosure 40 in this way, the inside of the region A can be made to have positive pressure relative to the space outside the region A. The space outside the region A is a space outside 1 m around the glass base material G.

In the method for manufacturing an optical fiber according to the present embodiment, the atmosphere within 1 m around the glass base material G is a clean environment in which the number of particles having a size of 0.3 μm or more and less than 0.5 μm is 15,000 particles/CF or less and in which the number of particles having a size of 0.5 μm or more and less than 1.0 μm is 3,500 particles/CF or less. Therefore, the optical fiber can be manufactured with less foreign matter around the glass base material G. Accordingly, since foreign matter is less likely to adhere to the glass base material G, the occurrence of spikes in the method for manufacturing an optical fiber is prevented.

In the method for manufacturing an optical fiber according to the present embodiment, the drawing step is performed while blowing clean air such that the clean air hits the glass base material G. Therefore, the clean environment around the glass base material G is maintained. Accordingly, adhesion of foreign matter to the glass base material G in the drawing step is prevented.

In the method for manufacturing an optical fiber according to the present embodiment, by blowing clean air such that the clean air hits the glass base material from two different directions, the clean environment around the glass base material is more easily maintained. Accordingly, mixing of foreign matter into the glass base material in the drawing step is prevented.

In the method for manufacturing an optical fiber according to the present embodiment, by providing the positive pressure within 1 m around the glass base material G relative to the space (the space outside the region A) outside 1 m around the glass base material G, it is particularly possible to prevent foreign matter from being mixed into the periphery of the glass base material G from the space outside the region A. Accordingly, adhesion of foreign matter to the glass base material G in the drawing step is prevented. The positive pressure may be 5 Pa or more within 1 m around the glass base material G relative to the space outside the region A.

According to the method for manufacturing an optical fiber in the present embodiment, the periphery of the glass base material G is covered with the enclosure 40, and thus adhesion of foreign matter to the glass base material G is prevented. Further, clean air is blown from the surfaces of the enclosure 40, and thus adhesion of foreign matter to the glass base material G in the drawing step is prevented.

Next, a result of verification on the frequency of spike occurrence due to differences in the clean environment around the glass base material in the drawing step will be described.

Table 1 shows the frequency of spike occurrence when the optical fiber is manufactured by changing the clean environment in the atmosphere within 1 m (the region A in FIG. 2) around the glass base material. Mm in Table 1 means one million meters.

TABLE 1

| | Number of | Number of | |
|---|---|---|---|
| | particles having | particles having | Frequency |
| | size of 0.3 μm | size of 0.5 μm | of spike |
| | or more and | or more and | occurrence |
| | less than 0.5 μm | less than 1.0 μm | [events/ |
| | [particles/CF] | [particles/CF] | Mm] |
| Sample 1 | 985 | 293 | 2 |
| Sample 2 | 2121 | 807 | 2 |
| Sample 3 | 5021 | 1242 | 3 |
| Sample 4 | 7120 | 1801 | 4 |
| Sample 5 | 8920 | 2289 | 7 |
| Sample 6 | 10215 | 2713 | 10 |
| Sample 7 | 15421 | 3546 | 30 |
| Sample 8 | 23100 | 5912 | 92 |
| Sample 9 | 33100 | 8471 | 372 |

As illustrated in Table 1, the smaller the number of particles present in the region A, the smaller the frequency of spike occurrence. In the manufacture of the optical fiber, it is preferable that the frequency of spike occurrence is 30 or less per 1,000,000 meters. Therefore, it has been confirmed that the atmosphere within 1 m around the glass base material G is preferably a clean environment in which the number of particles having a size of 0.3 μm or more and less than 0.5 μm is 15,000 particles/CF or less and the number of particles having a size of 0.5 μm or more and less than 1.0 μm is 3,500 particles/CF or less. The frequency of spike occurrence may be 10 or less per 1,000,000 meters, and may be 5 or less per 1,000,000 meters.

Although the present disclosure has been described in detail with reference to the specific embodiment, it is apparent to those skilled in the art that various changes and modifications can be made without departing from the spirit and scope of the present disclosure. In addition, the number, positions, shapes, and the like of the constituent members described above are not limited to those in the above embodiments, and can be changed to the numbers, positions, shapes, and the like suitable for carrying out the present disclosure.

In the present embodiment, the method for manufacturing a multi-core optical fiber is exemplified. Alternatively, a method for manufacturing a single-core optical fiber including one core portion of the optical fiber may also be used.

What is claimed is:

1. A method for manufacturing an optical fiber, the method comprising:
a drawing step of drawing a glass base material while feeding the glass base material to a heating furnace, to manufacture an optical fiber,
wherein the glass base material includes a core rod and a cladding tube into which the core rod is inserted,
wherein a support tube is bonded to an upper end of the cladding tube, to communicate with a gap between the core rod and the cladding tube,
wherein the drawing step includes bringing the gap and an internal space of the support tube into a state of being lower in pressure than atmospheric pressure, and
wherein an atmosphere within 1 m around the glass base material is made into a clean environment in which the number of particles having a size of 0.3 μm or more and less than 0.5 μm is 15,000 particles/CF or less and in which the number of particles having a size of 0.5 μm or more and less than 1.0 μm is 3,500 particles/CF or less.

2. The method for manufacturing an optical fiber according to claim 1,
wherein the drawing step includes blowing clean air such that the clean air hits the glass base material.

3. The method for manufacturing an optical fiber according to claim 2,
wherein the drawing step includes blowing the clean air such that the clean air hits the glass base material from at least two different directions.

4. The method for manufacturing an optical fiber according to claim 1,
wherein in the drawing step, positive pressure within 1 m around the glass base material is 5 Pa or more higher than atmospheric pressure.

5. The method for manufacturing an optical fiber according to claim 1,
wherein in the drawing step:
a periphery of the glass base material is covered with a covering portion that is provided above the heating furnace, and
clean air is blown from the covering portion.
